(19) United States
(12) Patent Application Publication
(10) Pub. No.: US 2022/0172697 A1
(43) Pub. Date: Jun. 2, 2022

(54) TONE-ENHANCING DRUM SHELL AND METHODS OF MAKING AND USING SAME

(71) Applicant: Hyuk Jae PARK, Port Coquitlam (CA)

(72) Inventor: Hyuk Jae PARK, Port Coquitlam (CA)

(21) Appl. No.: 17/431,000

(22) PCT Filed: Feb. 15, 2019
(86) PCT No.: PCT/CA2019/050190

§ 371 Date: Aug. 13, 2021

(51) Int. Cl. G10D 13/22; G10D 13/24; G10D 13/02

(52) U.S. Cl. CPC G10D 13/22; G10D 13/18; G10D 13/02; G10D 13/24

(57) ABSTRACT

A drum having modified tone qualities is provided. The drum has a generally cylindrical inner shell positioned within a generally cylindrical outer shell. The inner shell has at least one sound-transmitting aperture defined therethrough so that the sound-transmitting aperture provides an unobstructed passageway for sound waves to pass through to reach the outer shell. In some aspects, an insert for modifying the tone qualities of a drum is provided. In some aspects, the outer shell has one or more inwardly extending protrusions co-located with and extending through the at least one sound transmitting aperture.

### TECHNICAL FIELD

Some embodiments of the present invention relate to a drum shell for producing an enhanced sound. Some embodiments of the present invention relate to a drum shell insert for causing a drum to produce an enhanced sound. Some embodiments of the present invention relate to methods of making such drum shells or drum shell inserts, and to methods of producing an enhanced drum sound using such drum shells or drum shell inserts. Some embodiments of the present invention relate to drum shells for snare drums or drum shell inserts for snare drums for causing the snare drum to produce an enhanced sound.

### BACKGROUND

The drum is one of the key percussion instruments played today. The shell of a drum has a significant impact on the volume and tone qualities of the drum. Drums often have a single shell that is made of wood, metal or fiberglass. In general, the sound qualities of a wooden drum shell can be characterized as warm and smooth. The sound qualities of a metal drum shell can generally be characterized as clear, bright and loud.

With reference to FIG. 1, a prior art drum that is a snare drum 20 is illustrated. Snare drum 20 has a shell 22 that is of generally cylindrical shape. Shell 22 defines a generally hollow interior cavity, and has first and second opposed open ends. Drumheads are stretched under tension across each of the first and second opposed open ends of shell 22.

One drumhead, not visible in FIG. 1, is the “batter head”, i.e. the head of the drum that is struck with a drumstick during conventional methods of playing snare drum 20, and the other drumhead 32 is the “snare head”, or the head that is contacted by the snares 34 during playing of snare drum 20.

Snare drum 20 is also provided with a plurality of tensioning brackets 36, which can be used to adjust the tautness of the first and second drumheads. A typical method of affixing the drumheads to shell 22 is to use hoops to engage peripheral edges of each one of the drumheads, and first and second clamp frames 38, 40 are engaged around the outer periphery of each one of the hoops. Tensioning brackets 36 extend between the respective clamp frames 38, 40, so that the clamp frames 38 and 40 can be moved in axial directions in order to adjust the tension of the drumheads.

A plurality of snares 34, or wires, that can be placed in contact with snare head 32 are also provided. Snares 34 are typically made from a material such as animal gut or metal wires, although any desired material can be used. A snare release mechanism 42 is frequently provided, so that snares 34 can be moved out of contact with snare head 32 when snare drum 20 is not in use (e.g. to avoid the creation of resonant sounds when other instruments are played).

When snare drum 20 is played, a user will strike the batter head with an appropriate implement, e.g. a drumstick or wire brush. A primary sound is created by the striking of the batter head, which will cause vibration of the batter head. This vibration will in turn be transmitted to snare head 32 via air contained inside the hollow interior of drum shell 22. This causes snare head 32 to vibrate so as to cause further vibration, which can be transmitted to the batter head via air contained inside the hollow interior of drum shell 22. This vibration of both the snare head 32 and the batter head produces a secondary sound. Thus, the sound produced by snare drum 20 is produced by a combination of the primary impact of an implement such as a drumstick on the batter head and the vibrations repeatedly transmitted between the batter head and the snare head 32. Snares 34 also vibrate as a result of the vibration of snare head 32, further contributing to the quality and nature of the sound produced by snare drum 20.

There remains a general desire for an improved shell for a drum or other percussion instrument for amplifying the sound volume and optimizing the tone qualities of the instrument. There is also a general desire for an improved structure for a drum or other percussion instrument that can take advantage of the sound properties of different materials.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect provides a drum shell for amplifying the sound volume and optimizing the tone qualities of a drum. The drum shell has a sound-enhancing inner housing sized and dimensioned to be mounted within the outer housing to form a multiple-shell structure. The inner housing has at least one sound-transmitting aperture defined therethrough.

One aspect provides a drum having a generally cylindrical outer housing. The drum also has a sound-enhancing inner housing sized and dimensioned to be mounted within the outer housing to form a multiple-shell structure. The inner housing has a generally cylindrical body and at least one sound-transmitting aperture defined through the cylindrical body. In some embodiments, the outer housing defines at least one inwardly extending protrusion collocated with the at least one sound-transmitting aperture of the inner housing.

Another aspect provides an insert for modifying the tone qualities of a drum having a generally cylindrical drum shell. The insert has a generally cylindrical hollow body sized and dimensioned to be axially and concentrically mounted within the drum shell to form a multiple-shell structure. The insert also defines at least one sound-transmitting aperture. The sound-transmitting aperture provides an unobstructed passageway for sound waves to pass through.

Another aspect provides a method for producing an enhanced drum sound. The method includes the step of causing air inside a hollow interior of a drum to be compressed. Some of the compressed air passes through a sound-transmitting aperture defined through an inner drum shell and then is reflected back into the hollow interior by an outer drum shell. The compressed air causes the inner drum shell and the outer drum shell to repeatedly vibrate, thereby producing soundwaves.

Another aspect provides method for producing an enhanced drum sound. The method includes the steps of compressing air inside a hollow interior of a drum having an inner shell and an outer shell, the inner shell of the drum having at least one sound-transmitting aperture defined therethrough, the outer shell of the drum having at least one inwardly extending projection extending through the at least one sound-transmitting aperture; reflecting a portion of the compressed air within a hollow interior of the drum off the inner shell; and reflecting a portion of the compressed air within the hollow interior of the drum off the at least one inwardly-extending projection.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an example of a prior art snare drum.

FIG. 2 shows an exploded view of an example embodiment of a snare drum having improved sound qualities.

FIG. 3 shows a perspective view of an inner shell mounted axially concentrically inside an outer shell in the embodiment illustrated in FIG. 2.

FIG. 4 shows a perspective view of an example embodiment of an insert that can be used to modify a drum to provide it with improved sound qualities.

FIG. 5 shows an exploded view of an example embodiment wherein the outer shell is provided with at least one inwardly extending protrusion co-located with the at least one sound-transmitting aperture in the inner shell.

FIG. 6 shows a top view of the outer shell of the embodiment of FIG. 5.

FIG. 7 shows a sectional view of the inner and outer shells taken through a middle section of the embodiment of FIG. 5.

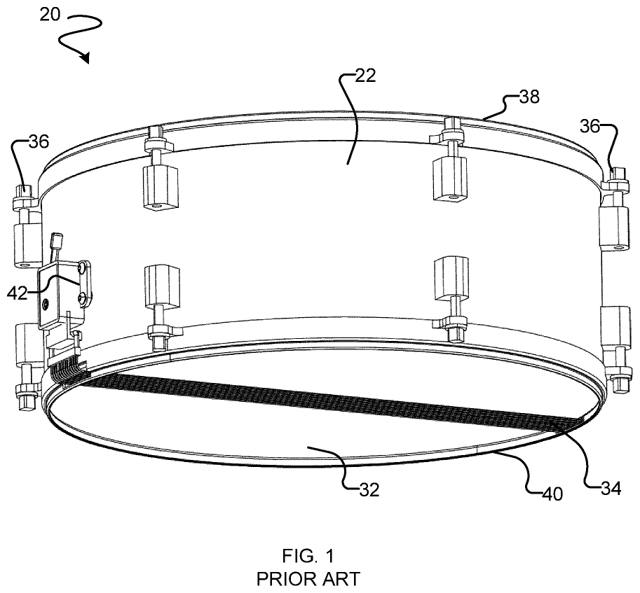

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used herein, the term “inwardly” means a direction towards the axial centreline of a drum. The term “outwardly” means the opposite of inwardly, i.e. a direction away from the axial centreline of a drum.

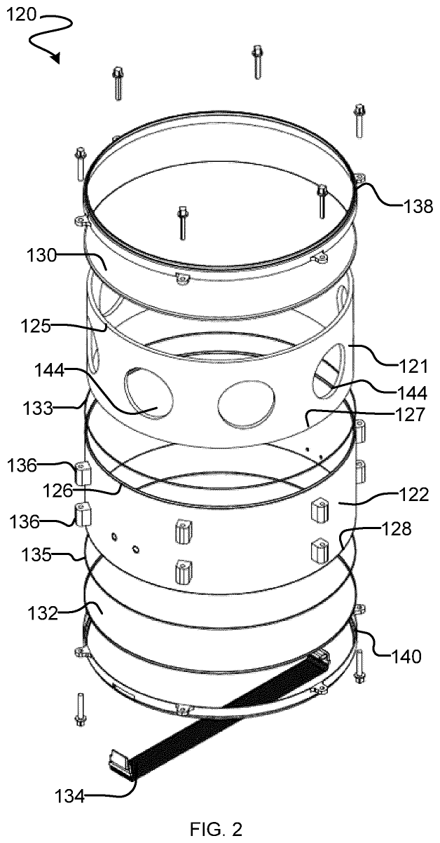

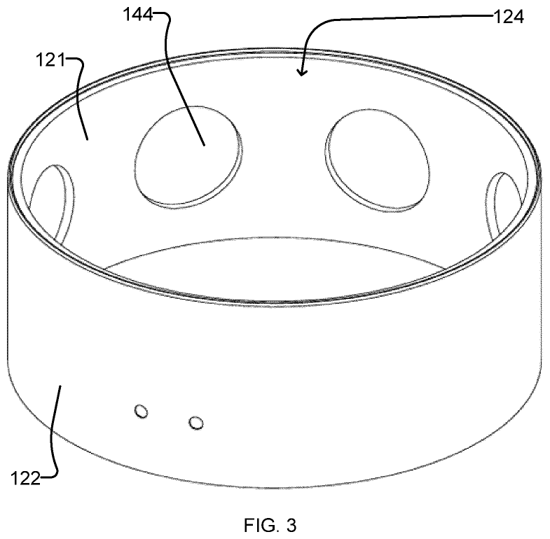

With reference to FIGS. 2 and 3, an example embodiment of a snare drum 120 having improved sound qualities is illustrated. While an exemplary embodiment is described with reference to a snare drum, it will be understood by those skilled in the art that other percussion instruments, including other types of drums, could be modified in a similar manner to produce desired changes in tone. For example, in alternative embodiments, the drum could be a tom-tom, a bass drum, a marching drum, or the like.

Snare drum 120 has a cylindrical hollow outer shell 122 and a cylindrical inner shell 121 positioned within the interior of outer shell 122 to form a multiple-shell structure. Inner shell 121 and outer shell 122 are formed from different materials to enhance the sound properties of snare drum 120, as described in greater detail below. Although in the illustrated embodiment, inner shell 121 is illustrated as being cylindrical in shape, in alternative embodiments, inner shell 121 can be provided with other shapes, so long as at least a portion of the outer surface area of inner shell 121 is in direct contact with at least a portion of the inner surface area of outer shell 122 as described below.

Inner shell 121 is axially concentrically mounted within outer shell 122 and the outer surface of inner shell 121 is in direct contact with the inner surface of outer shell 122, i.e. is no space provided between inner shell 121 and outer shell 122 at the points where inner shell 121 contacts outer shell 122. The external diameter of inner shell 121 is just slightly smaller than the internal diameter of outer shell 122, to facilitate the direct contact between the two shells. In some embodiments, the entirety of the outer surface area of inner shell 121 is in direct contact with the inner surface of outer shell 122. Inner shell 121 can be secured in position within outer shell 122 in any suitable manner, for example by using a press or friction fit, or by using suitable adhesives or fasteners such as screws or bolts.

Outer shell 122 has two opposed open ends 126, 128 and inner shell 121 has two opposed open ends 125, 127. The height of inner shell 121 corresponds to the height of outer shell 122, so that the two opposed open ends 126, 128 of outer shell 122 and the corresponding two opposed ends 125, 127 of inner shell 121 form bearing edges of snare drum 120. The bearing edge is the portion of the drum shell that contacts the drumheads 130, 132. Thus, both inner shell 121 and outer shell 122 contact the drumheads 130, 132.

The angle and shape of the bearing edges formed by ends 125/126 and 127/128 affect the amount of contact between batter head 130 and shells 121, 122, which can contribute to the resonance and tone of snare drum 120. Opposed open ends 126, 128 of outer shell 122 and opposed ends 125, 127 of inner shell 121 can together form any type of bearing edges known in the art, e.g. 45-degree, 45-degree with countercut, 45-degree roundover, dual 45-degree, 30-degree, roundover, extreme roundover, hybrid, or the like.

Over opposed ends 125/126 and 127/128, a first drumhead 130 and second drumhead 132, respectively are stretched, to provide batter head 130 and snare head 132. First and second drumhead 130, 132 may be made from any suitable material, for example, natural leather or plastic. When first and second drumheads 130 and 132 are secured in position, bearing edges 125/126 and 127/128 are in direct contact with drumheads 130 and 132, respectively.

When snare drum 120 is played, a user will strike the batter head, i.e. drumhead 130 with an appropriate implement, e.g. a drumstick or wire brush. The striking of batter head 130 causes vibration of batter head 130, inner shell 121, and outer shell 122. Energy is transferred from batter head 130 to bearing edges 125/126 and 127/128 and then to shells 121, 122.

To secure first and second drumheads 130 and 132 in position across bearing edges 125/126 and 127/128, first and second hoops 133, 135 are provided and secured to the perimeter of drumheads 130, 132, respectively. First and second clamp frames 138, 140 are engaged around the outer periphery of each one of first and second hoops 133, 135, respectively to secure hoops 133, 135 and drumheads 130 and 132 in position. Tensioning brackets 136 are secured at uniform intervals on the exterior side of outer shell 122, and can be used to adjust the tension of drumheads 130 and 132. Snares 134 are stretched across snare head 132. Clamp frames 138, 140 encircle the outer edges of outer shell 122.

In some embodiments, outer shell 122 and inner shell 121 are made of different materials so that the tonal properties of drum 120 will incorporate properties of different materials. For example, in some embodiments, outer shell 122 is made of metal and inner shell 121 is made of wood. For example, in some embodiments, outer shell 122 is made of steel, brass, aluminum, copper, bronze, titanium, or the like. In some embodiments, inner shell 121 is made of maple, birch, mahogany, walnut, oak, beech, cherry, bubinga, poplar, ash or a combination thereof. In embodiments in which inner shell 121 is made of wood, any suitable wood construction can be used for inner shell 121, e.g. a solid wood structure, or a plywood structure made from any desired number of layers of plywood, e.g. 2 ply, 3 ply, 4 ply, 5 ply, 6 ply, 7 ply, 8 ply, 9 ply, 10 ply, 11 ply, 12 ply or more.

In alternative embodiments, outer shell 122 is made of wood and inner shell 121 is made of metal. For example, in some embodiments, outer shell 122 is made of maple, birch, mahogany, walnut, oak, beech, cherry, bubinga, poplar, ash or a combination thereof. In embodiments in which outer shell 122 is made of wood, any suitable wood construction can be used for outer shell 122, e.g. a solid wood structure, or a plywood structure made from any desired number of layers of plywood, e.g. 2 ply, 3 ply, 4 ply, 5 ply, 6 ply, 7 ply, 8 ply, 9 ply, 10 ply, 11 ply, 12 ply or more. In some such embodiments, inner shell 121 is made of steel, brass, aluminum, copper, bronze, titanium, or the like.

It is understood that materials other than wood or metal having unique sound qualities may independently be used in the production of outer shell 122 and inner shell 121 to create interesting tonal properties. Such materials include plastics, carbon fibre, acrylic and fiberglass.

Inner shell 121 and outer shell 122 can be provided in any desired thickness. In one example non-limiting embodiment, inner shell 121 has a thickness of 1, 2 or 3 mm, and outer shell 122 independently has a thickness of 1, 2 or 3 mm.

Inner shell 121 is provided with at least one sound-transmitting aperture 144 formed therethrough. In the illustrated embodiment, inner shell 121 is provided with eight identically-sized generally circular sound-transmitting apertures 144 defined therethrough, and apertures 144 are generally evenly spaced apart about the outer perimeter of inner shell 121. Apertures 144 are also generally evenly axially spaced apart from opposed ends 125 and 127 of inner shell 121. Sound-transmitting apertures 144 are unobstructed, that is provide a clear path for fluid flow therethrough. An unobstructed aperture is to be contrasted with an aperture that might be used for containing or supporting some other structure that would block the transmission of fluid or soundwaves therethrough, e.g. an aperture through which a bolt or other fastening member has been inserted.

In alternative embodiments, different numbers of sound-transmitting apertures 144 could be provided, e.g. 1, 2, 3, 4, 5, 6, 7, 8, 9, 10 or more apertures. In some embodiments, a plurality of sound-transmitting apertures 144 are provided. Also the size, shape and relative positioning of sound-transmitting apertures 144 can be varied in alternative embodiments, e.g. sound-transmitting apertures 144 can be triangular, square, polyhedral, symmetrical or asymmetrical, or other shapes. The sound-transmitting apertures can be positioned at a variety of different axial heights rather than generally evenly spaced from opposed ends 125 and 127, and the distribution of the sound-transmitting apertures can be asymmetrical. The number, size, shape and positioning of the apertures is not critical and is not limited to the illustrated embodiments.

Without being bound by theory, sound-transmitting apertures 144 are believed to allow for the more ready transmission of vibration occurring within the hollow interior 124 of snare drum 124 into outer shell 122, to thereby alter and enhance the character and quality of sound produced by snare drum 120 as compared to a conventional snare drum with only one drum shell. For example, in embodiments in which inner shell 121 is made from wood and outer shell 122 is made from metal, it is believed that the sound-transmitting apertures 144 allow the sound produced by snare drum 120 to have a direct metallic tone as the vibrations touch the metallic shell, while retaining a softer wooden foundation to the sound, thereby yielding a drum with a sharp but warm tone.

Without being bound by theory, in embodiments in which outer shell 122 is thicker, it may be desirable to provide larger sound-transmitting apertures 144, to facilitate transmission of a greater proportion of the sound waves generated inside hollow interior 124 to outer shell 122.

In some embodiments, outer shell 122 is fully enclosed, i.e. there are no unobstructed sound or air transmitting apertures provided in outer shell 122. Without being bound by theory, it is believed that providing a fully enclosed outer shell 122 avoids having a “dry” sound to the snare drum 120. In alternative embodiments, outer shell 122 includes one or more air-transmitting apertures as is known in the art (not shown), to allow for pressure equalization between the hollow interior 124 of snare drum 120 and the external atmosphere when batter head 130 is struck by a drumstick.

When batter head 130 is struck by a drumstick, batter head 130 vibrates and air inside the hollow interior 124 of snare drum 120 is compressed. Without being bound by theory, vibrations from batter head 130 are believed to be transmitted to both inner shell 121 and outer shell 122 via the bearing edges formed by opposed ends 125/126, 127/128 and cause both shells to vibrate, i.e. to excite both inner shell 121 and outer shell 122. The compressed air inside hollow interior 124 exerts an outward pressure on inner shell 121 and snare head 132. A first portion of the compressed air passes through sound-transmitting apertures 144 and a second portion of the compressed air is directly reflected back into the hollow interior 124 by inner shell 121. The first portion of the compressed air that passes through sound-transmitting apertures 144 is directly reflected back into hollow interior 124 by outer shell 122. “Directly” means the compressed air contacts the stated element, here outer shell 122, without striking any intermediary elements. The compressed air also causes batter head 130, snare head 132, inner shell 121 and outer shell 122 to repeatedly vibrate. Sound-transmitting apertures 144 are unobstructed when snare drum 120 is being played, so that the sound waves created within hollow interior 124 by vibration of batter head 132 can pass freely through sound-transmitting apertures 144 and enter and/or be reflected by outer shell 122.

Without being bound by theory, the provision of inner and outer shells made from different materials allows for modification of the tonal properties of the drum, and depending on the composition of the inner and outer shells, different effects can be emphasized by different drum playing styles. For example, in embodiments in which outer shell 122 is made from metal and inner shell 121 is made from wood, playing softly on batter head 132, e.g. by ghosting, would reveal the warm wood tone of inner shell 121, and playing hard, e.g. by playing rim shots on first clamp frame 138, would reveal the bright and loud metal tone of outer shell 122.

In the illustrated embodiment, the diameter of sound-transmitting apertures 144 is approximately 60% of the height of inner shell 121. In some embodiments, the diameter of sound-transmitting apertures 144 is in the range of 10% to 90% of the height of inner shell 121. In alternative embodiments, the sizes and diameters of sound-transmitting apertures 144 can be varied.

Without being bound by theory, the size of the sound-transmitting apertures 144 may affect the amount of sound energy that is transmitted to and reflected by outer shell 122. For example, the larger the dimensions of sound-transmitting apertures 144, the more sound energy will be transmitted to outer shell 122. Thus, the dimensions of sound-transmitting apertures 144 can be adjusted depending on the desired acoustic properties of the particular drum being constructed.

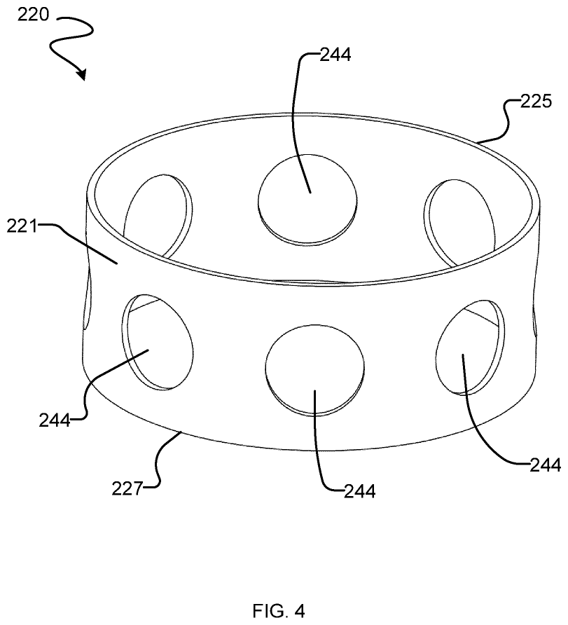

In some embodiments, as illustrated in FIG. 4, an insert 220 for modifying the tone qualities of a drum is provided. Insert 220 can be concentrically mounted within the housing of an existing drum to form a multiple-shell structure, thereby modifying and/or enhancing the sound qualities of the modified drum.

Insert 220 has a generally cylindrical hollow body 221 with a first and a second opposed open ends 225, 227. In alternative embodiments, insert 220 can be provided with other shapes, so long as insert 220 is configured so that at least a portion of the outer surface area of insert 220 will be in direct contact with at least a portion of the inner surface area of the existing drum into which insert 220 is to be inserted.

Insert 220 is dimensioned to have an axial height corresponding to the axial height of the existing drum into which it is to be inserted so that both the existing drum and insert 220 will together form the bearing edges that contact both drumheads of the drum, as described above for inner shell 121 being configured to sit within outer shell 122. Insert 220 should further have an external diameter that is just slightly smaller than the internal diameter of the existing drum, so that at least a portion of the outer surface area of insert 220 will be in direct contact with at least a portion of the inner surface of the existing drum. In some embodiments, the entirety of the outer surface area of insert 220 is in direct contact with the inner surface area of the existing drum when insert 220 is installed.

When mounted within the housing of a drum having a generally cylindrical drum shell, insert 220 forms an inner shell and the drum shell of the existing drum forms an outer shell that together behave in a manner similar to inner shell 121 and outer shell 122 described above.

Insert 220 is provided with at least one sound-transmitting aperture 244. In the illustrated embodiment, insert 220 has eight identical sound-transmitting apertures 244 defined through shell 221. In the illustrated embodiment, sound-transmitting apertures 244 are circular and are evenly spaced apart along the circumference of shell 221, and are at an axial height that is evenly spaced from both of opposed ends 225 and 227. Apertures 244 function in a similar manner as described above for sound-transmitting apertures 144 to enhance the quality of sound produced by a drum into which insert 220 has been inserted. In alternative embodiments, the dimensions, position, configuration and/or number of sound-transmitting apertures 244 provided in shell 221 could be varied as described above for sound-transmitting apertures 144 of inner shell 121.

Insert 220 can be made from any desired material depending on the desired tonal modification of the existing drum. In some embodiments, insert 220 is made of wood. It is understood that specific types of wood with interesting tonal and structural properties can be used to construct insert 220. For example, insert 220 can be made of maple, birch, mahogany, walnut, oak, beech, cherry, bubinga, poplar, ash or a combination thereof. In some embodiments, insert 220 is intended to be inserted into an existing drum that is made from metal. In alternative embodiments, insert 220 is made of metal, e.g. steel, brass, aluminum, copper, bronze, titanium or the like, and is intended to be inserted into an existing drum that is made from wood. In alternative embodiments, insert 220 is made of a material such as plastic, carbon fibre, acrylic or fiberglass.

Insert 220 may be made in any desired thickness. In some embodiments, insert 220 is made of plywood consisting of single ply, 2 ply, 3 ply, 4 ply, 5 ply, 6 ply, 7 ply, 8 ply, 9 ply, 10 ply, 11 ply, 12 ply or more cross laminated wood materials. In some embodiments, the thickness of insert 220 is about 1, 2, 3, 4 or 5 mm.

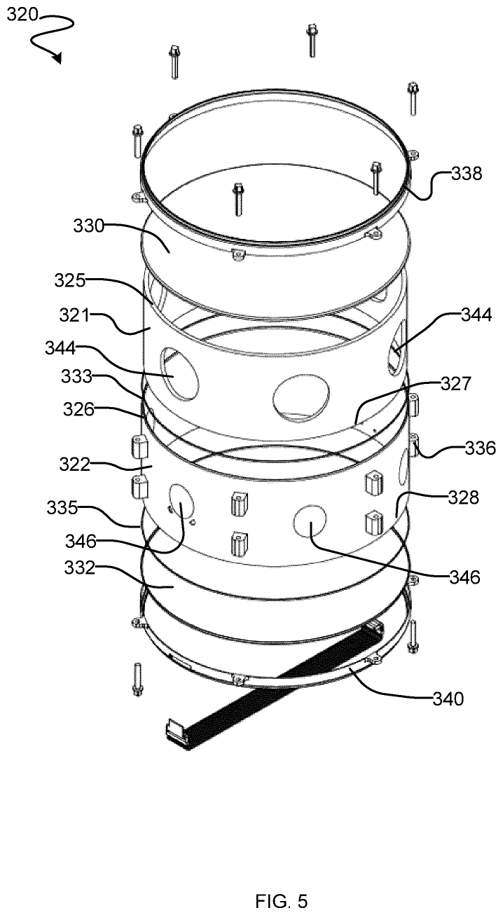

With reference to FIGS. 5, 6 and 7, a further embodiment of a snare drum 320 having enhanced sound qualities is illustrated. Snare drum 320 is generally similar to snare drum 120 as shown in FIG. 2, and like elements have been illustrated with reference numerals incremented by 200 and are not further described again.

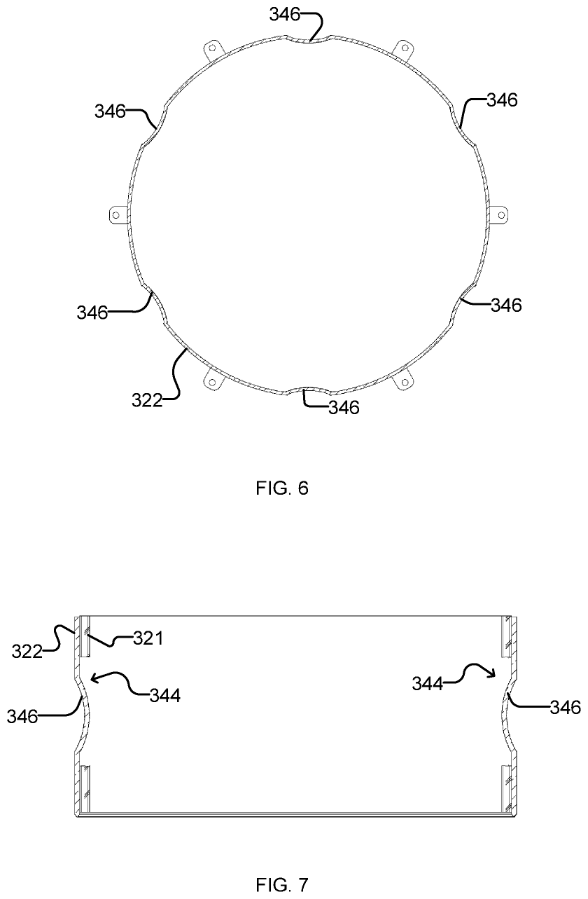

As best seen in FIG. 6, instead of a continuous and smooth outer surface as illustrated for outer shell 122, outer shell 322 has a plurality of sound-enhancing protrusions 346 projecting inwardly from the main body of outer shell 322 towards an axial centreline of snare drum 320 through sound-transmitting apertures 344. Sound-enhancing protrusions 346 are positioned adjacent to and project inwardly into or through a corresponding one of sound-transmitting apertures 344.

Each one of sound-enhancing protrusions 346 is collocated with, i.e. positioned adjacent to, a corresponding one of sound-transmitting apertures 344. Accordingly, because the illustrated embodiment has six sound-transmitting apertures 344 spaced evenly about the outer perimeter of inner shell 321, outer shell 322 is correspondingly provided with six sound-enhancing protrusions 346 that share the same shape (i.e. generally circular in the illustrated embodiment, although other shapes can be used) and are similar in diameter to the sound-transmitting apertures 344. When snare drum 320 is assembled, sound-transmitting apertures 344 of inner shell 321 align with sound-enhancing protrusions 346 of outer shell 322 as shown in FIG. 7. Compared to snare drum 120, sound-enhancing protrusions 346 provide a larger surface area of outer shell 322 to reflect compressed air within snare drum 320, resulting in unique acoustic properties. Further without being bound by theory, it is believed that the projection of outer shell 322 into hollow interior 324 allows the different sound qualities produced by the respective different materials of the inner shell 321 and the outer shell 322 to mix in a unique manner.

The extent to which sound-enhancing protrusions 346 extend radially inwardly through sound-transmitting apertures 344 can be varied in different embodiments as desired to alter the characteristics of the sound produced by snare drum 320. In one example embodiment, sound-enhancing protrusions 346 project radially inwardly through sound-transmitting apertures 344 by an amount that is approximately equal to the thickness of inner shell 321, i.e. so that the innermost portion of the inner surface of sound-enhancing protrusion extends inwardly to a point parallel with the inner surface of inner shell 321. In other example embodiments, sound-enhancing protrusions 346 project radially inwardly through sound-transmitting apertures by an amount that is approximately equal to 10% to 250% of the thickness of inner shell 321, including any value therebetween e.g. 25, 50, 75, 100, 125, 150, 175, 200 or 225%.

As best seen in FIGS. 6 and 7, sound-enhancing protrusions 346 project radially inwardly to form a generally convex surface relative to the inner surface of outer shell 322. The illustrated embodiment, sound-enhancing protrusions 346 have an outer perimeter that is generally circular in shape. In alternative embodiments, other shapes could be used for sound-enhancing protrusions 346, so long as sound-transmitting apertures 344 are correspondingly shaped to receive sound-enhancing projections 346, e.g. the outer of sound-enhancing projections could be oval in shape, or any other desired shape, e.g. triangular, square, polyhedral, asymmetrical, or the like.

Without being bound by theory, the operation of snare drum 320 is generally similar to that of snare drum 120, except instead of soundwaves exiting inner shell 321 via sound-transmitting apertures 344 before contacting outer shell 322, at least a portion of such soundwaves are reflected within the hollow interior 324 of snare drum 320 by sound-enhancing protrusions 346, in some cases without first passing through sound-transmitting apertures 344 (i.e. to the extent that sound-enhancing protrusions 346 extend radially inwardly of sound-transmitting apertures 344, air does not need to first pass through sound-transmitting aperture 344 to reach sound-enhancing protrusion 346). When batter head 330 is struck by a drumstick, batter head 330 vibrates and air inside the hollow interior 324 of snare drum 320 is compressed. The compressed air inside hollow interior 324 exerts an outward pressure on inner shell 321 and snare head 332. A first portion of the compressed air is reflected back into the hollow interior 324 directly by inner shell 321 and a second portion of the compressed air is reflected back in to the hollow interior 324 directly by outer shell 322. “Directly” means the compressed air contacts the stated element without striking any intermediary elements. For example, when the compressed air is reflected back into hollow interior 324 directly by inner shell 321, the compressed air is in direct contact with and exerts an outward pressure on the inner shell 321. When the compressed air is reflected back into hollow interior 324 directly by outer shell 322, the compressed air is in direct contact with and exerts an outward pressure on the outer shell 322.

In some embodiments, sound-enhancing projections 346 are collocated and aligned with sound-transmitting apertures 344, and each sound-enhancing projection 346 occupies the entirety of its respective sound-transmitting aperture 344. In some embodiments, e.g. as illustrated in FIG. 7, sound-enhancing projections 346 are slightly smaller in diameter or external perimeter than the corresponding sound-transmitting apertures 344, so that each sound-enhancing projection 346 occupies only a portion of its corresponding sound-transmitting aperture 344.

In some embodiments, as best shown in FIG. 7, sound-enhancing projections 346 are collocated and aligned with sound-transmitting apertures 344, and each sound-enhancing projection 346 occupies a portion but not the entirety of its respective sound-transmitting aperture 344. When batter head 330 is struck by a drumstick, inner shell 321 and outer shell 322 vibrate and air inside the hollow interior 324 of snare drum 320 is compressed. A first portion of the compressed air is reflected back into the hollow interior 324 directly by inner shell 321. A second portion of the compressed air is reflected back in to the hollow interior 324 directly by sound-enhancing projections 346 of outer shell 322 without first passing through sound-transmitting apertures 344. A third portion of the compressed air passes through the peripheral portion of sound-transmitting aperture 344 that is not occupied by sound-enhancing projection 346 and is then reflected back into the hollow interior 324 directly by outer shell 322.

Without being bound, sound-enhancing protrusions 346 can change the resonance and tone of outer shell 322. Furthermore, sound-enhancing protrusions 346 provide a visual feature that can be observed from the outside of snare drum 320 to verify that the unique sound-enhancing features described herein are present in such snare drum.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A drum comprising:
a generally cylindrical outer housing defining a continuous outer surface;
a sound-enhancing inner housing sized and dimensioned to be mounted within the outer housing, the inner housing being secured in position within the outer housing, the inner housing comprising at least one sound-transmitting aperture defined therethrough.

2. A drum as defined in claim 1, wherein the sound-transmitting aperture provides an unobstructed passageway for sound waves to pass through.

3. A drum as defined in claim 1, wherein the inner housing is generally cylindrical, optionally wherein an axial height of the outer housing is the same as an axial height of the inner housing.

4. (canceled)

5. A drum as defined in claim 1, wherein at least a portion of an outer surface of the inner housing is in direct contact with at least a portion of an inner surface of the outer housing.

6. A drum as defined in claim 1, wherein the entirety of the outer surface of the inner housing is in direct contact with the entirety of the inner surface of the outer housing.

7. A drum as defined in claim 1, wherein both the outer housing and the inner housing form bearing edges for the drum.

8. A drum as defined in claim 1, wherein the outer housing is made of a different material than the inner housing, optionally wherein the inner housing comprises wood, and/or optionally wherein the outer housing comprises metal.

9. (canceled)

10. (canceled)

11. A drum as defined in claim 1, comprising between two and ten sound-transmitting apertures, wherein the sound-transmitting apertures are optionally generally circular in shape.

12. A drum as defined in claim 1, wherein the sound-transmitting apertures are generally evenly spaced about a circumference of the inner housing, and wherein the sound transmitting apertures are generally evenly spaced away from opposed ends of the inner shell.

13. A drum as defined in claim 1, the outer housing comprising at least one inwardly extending protrusion collocated with and projecting through the at least one sound-transmitting aperture.

14. A drum as defined in claim 13, wherein the inwardly extending protrusion extends radially inwardly by an amount that is approximately equal to 10% to 250% of the thickness of the inner housing.

15. A drum as defined in claim 1, wherein the inwardly extending protrusion comprises a generally convex shape, and wherein optionally the outer perimeter of the inwardly extending protrusion comprises a circular or oval shape.

16. An insert for modifying the tone qualities of a drum having a generally cylindrical drum shell defining a continuous sound reflecting surface, the insert comprising:
a generally cylindrical hollow body sized and dimensioned to be axially and concentrically mounted within the drum shell; and
at least one sound-transmitting aperture defined through the generally cylindrical hollow body, wherein the sound-transmitting aperture provides an unobstructed passageway for sound waves to pass through when the insert is mounted within the drum shell.

17. An insert as defined in claim 16, wherein the insert is configured to be entirely surrounded by the continuous sound reflecting surface of the drum shell.

18. An insert as defined in claim 16, wherein an axial height of the insert is equal to an axial height of the drum shell.

19. An insert as defined in claim 16, wherein the generally cylindrical hollow body is made of a different material than that of the drum shell optionally wherein the generally cylindrical hollow body comprises wood.

20. (canceled)

21. An insert as defined in claim 16, wherein at least a portion of an outer surface of the generally cylindrical hollow body is in direct contact with at least a portion of an inner surface of the drum shell when the insert is mounted within the drum shell.

22. An insert as defined in claim 16, wherein the entirety of the outer surface of the generally cylindrical hollow body is in direct contact with the sound reflecting surface of the drum shell.

23. An insert as defined in claim 16, wherein the generally cylindrical hollow body has an external diameter which is just slightly smaller than an internal diameter of the drum shell.

24. A method for producing an enhanced drum sound, the method comprising:
compressing air inside a hollow interior provided by a generally cylindrical outer shell of a drum, the outer shell defining a continuous outer surface;
reflecting a first portion of the compressed air back into the hollow interior directly by an inner shell of the drum; and
reflecting a second portion of the compressed air back into the hollow interior directly by outer shell of the drum by allowing the second portion of the compressed air to pass through at least one sound-transmitting aperture defined through the inner shell of the drum.

25. (canceled)

26. (canceled)

27. (canceled)

28. (canceled)

29. (canceled)

30. (canceled)
